(19) United States
(12) Patent Application Publication
(10) Pub. No.: US 2019/0270088 A1
(43) Pub. Date: Sep. 5, 2019

(54) MATERIAL PROCESSING DEVICE AND SHEET MANUFACTURING APPARATUS

(71) Applicant: SEIKO EPSON CORPORATION, Tokyo (JP)

(72) Inventor: Hiroshi TANAKA, Matsumoto-shi (JP)

(73) Assignee: SEIKO EPSON CORPORATION, Tokyo (JP)

(21) Appl. No.: 16/291,786

(22) Filed: Mar. 4, 2019

(30) Foreign Application Priority Data
Mar. 5, 2018 (JP) 2018-038517

(51) Int. Cl. B02C 23/14; F26B 17/04

(52) U.S. Cl. CPC B02C 23/14; D21B 1/08; F26B 17/04

(57) ABSTRACT

A material processing device that consistently captures over a long time unnecessary dust contained in defibrated material, and a sheet manufacturing apparatus. A material processing device has: a defibrator configured to defibrate fibrous feedstock containing fiber and produce defibrated material; a separator configured to separate dust contained in the defibrated material from the defibrated material; and a collector configured to capture the dust separated by the separator, and having at least one air permeable bag with an inlet through which the dust inflows with air, and which captures the dust entering through the inlet, a pressure adjuster configured to positively pressurize the inside of the bag relative to the outside of the bag, and a vibrator configured to apply vibration to the bag.

### BACKGROUND

### 1. Technical Field

The present invention relates to a material processing device and a sheet manufacturing apparatus.

### 2. Related Art

Systems for manufacturing sanitary paper such as tissue paper, toilet paper, and paper towels are known from the literature. See, for example, JP-A-2013-202139. When manufacturing sanitary paper with the manufacturing system described in JP-A-2013-202139, paper dust may stick to the sanitary paper. When this happens, the paper dust adhering to the sanitary paper can be removed by a paper dust remover. The paper dust remover has a blower that sprays air against the sanitary paper to remove the paper dust from the sanitary paper, and a vacuum that suctions the air carrying the paper dust removed from the sanitary paper. The vacuum has a dust collector with a filter that captures the paper dust.

As the paper dust is captured by the dust collector in the manufacturing system described in JP-A-2013-202139, the paper dust gradually builds up on the filter. The filter thus gradually becomes clogged, and the suction power of the vacuum drops. As a result, it becomes increasingly difficult to sufficiently suction and remove the paper dust.

### SUMMARY

The invention is directed to solving this problem as described below.

A material processing device according to the invention includes a defibrator configured to defibrate fibrous feedstock containing fiber and produce defibrated material; a separator configured to separate dust contained in the defibrated material from the defibrated material; and a collector configured to capture the dust separated by the separator, and having at least one air permeable bag with an inlet through which the dust inflows with air, and which captures the dust entering through the inlet, a pressure adjuster configured to positively pressurize the inside of the bag relative to the outside of the bag, and a vibrator configured to apply vibration to the bag.

A sheet manufacturing apparatus according to another aspect of the invention includes a material processing device according to the invention, and makes a sheet from the defibrated material after dust is removed therefrom.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic side view showing the configuration of a sheet manufacturing apparatus according to a first embodiment of the invention.

FIG. 2 is a schematic side view showing the configuration of a material processing device of the sheet manufacturing apparatus shown in FIG. 1.

FIG. 3 is a schematic side view showing the configuration of a material processing device of the sheet manufacturing apparatus shown in FIG. 1.

FIG. 4 is a view from the direction of arrow A in FIG. 2.

FIG. 5 is a schematic side view illustrating a step in the process of replacing a bag of the material processing device in the sheet manufacturing apparatus shown in FIG. 1.

FIG. 6 is a schematic side view illustrating a step in the process of replacing a bag of the material processing device in the sheet manufacturing apparatus shown in FIG. 1.

FIG. 7 is a timing chart illustrating the relationship between operation of a valve and operation of a vibrator of the material processing device in the sheet manufacturing apparatus shown in FIG. 1.

FIG. 8 is an oblique view of the bag in a second embodiment of the material processing device of the invention.

FIG. 9 is an oblique view of the bag in a third embodiment of the material processing device of the invention.

FIG. 10 is an oblique view of the bag in a fourth embodiment of the material processing device of the invention.

FIG. 11 is an oblique view of the bag in a fifth embodiment of the material processing device of the invention.

FIG. 12 is a schematic plan view of the bag in a sixth embodiment of the material processing device of the invention.

FIG. 13 is a schematic plan view showing the configuration of a seventh embodiment of the material processing device of the invention.

FIG. 14 is a schematic plan view showing the configuration of a seventh embodiment of the material processing device of the invention.

FIG. 15 is a section view through line B-B in FIG. 13.

FIG. 16 is a section view through line C-C in FIG. 14.

FIG. 17 is a schematic plan view showing the configuration of an eighth embodiment of the material processing device of the invention.

### DESCRIPTION OF EMBODIMENTS

Preferred embodiments of a material processing device and a sheet manufacturing apparatus according to the present invention are described below with reference to the accompanying figures.

### Embodiment 1

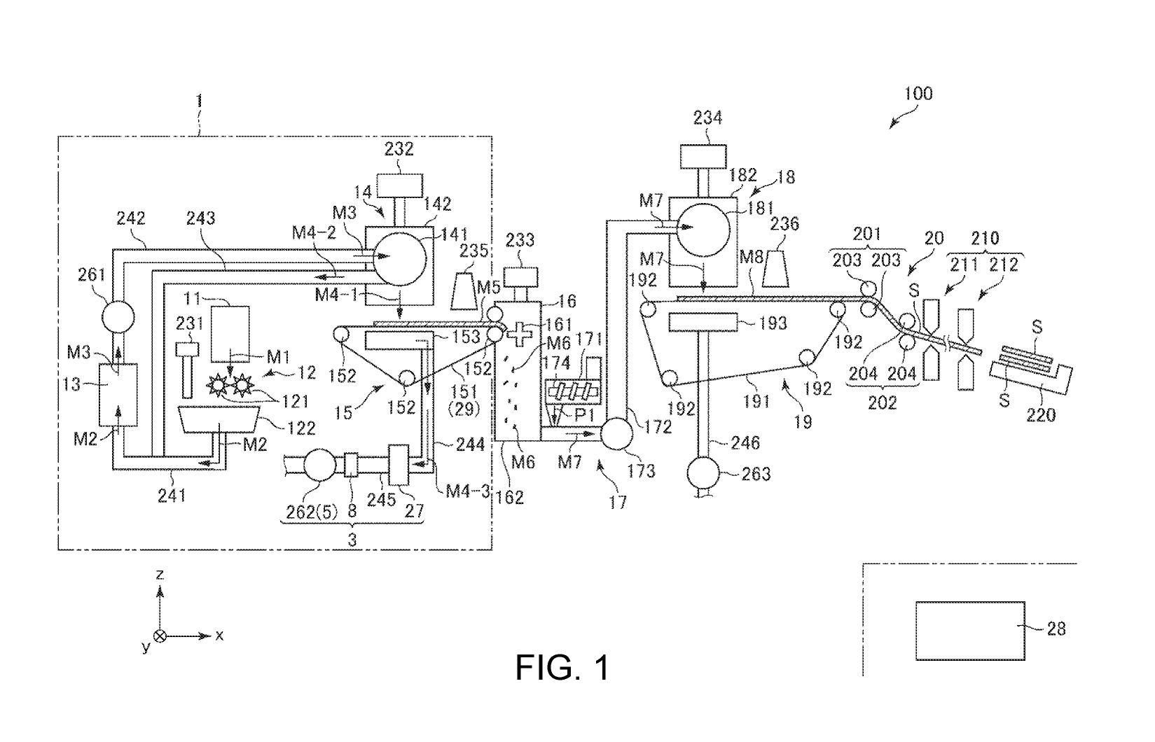

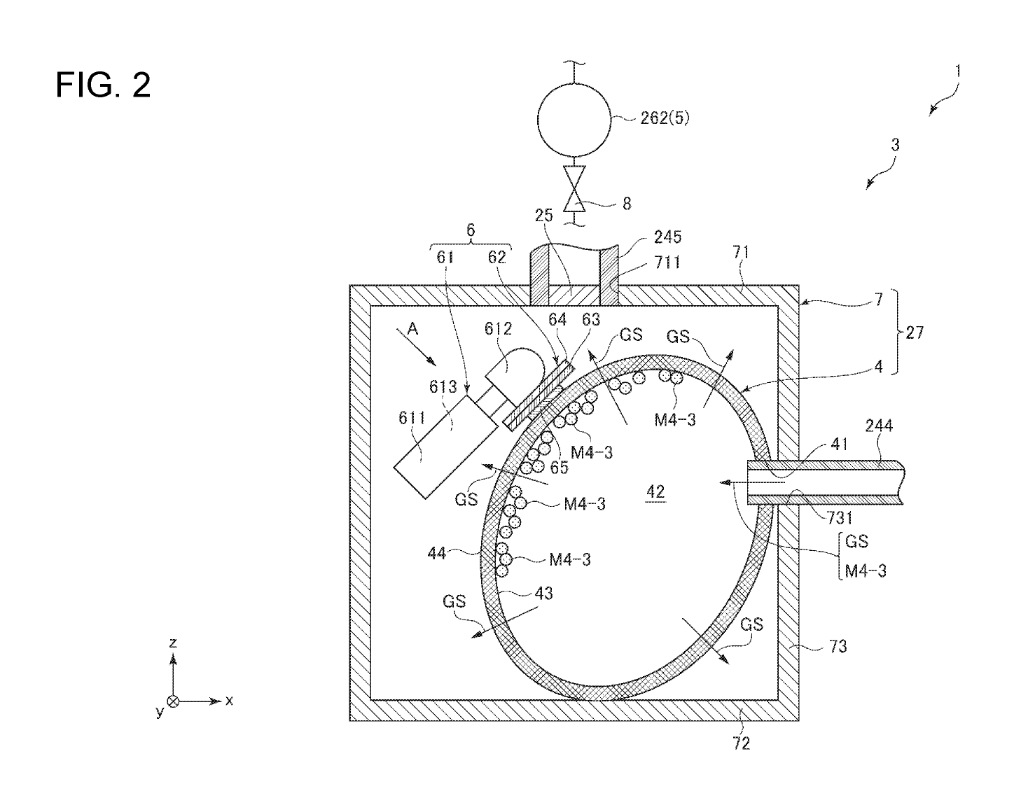

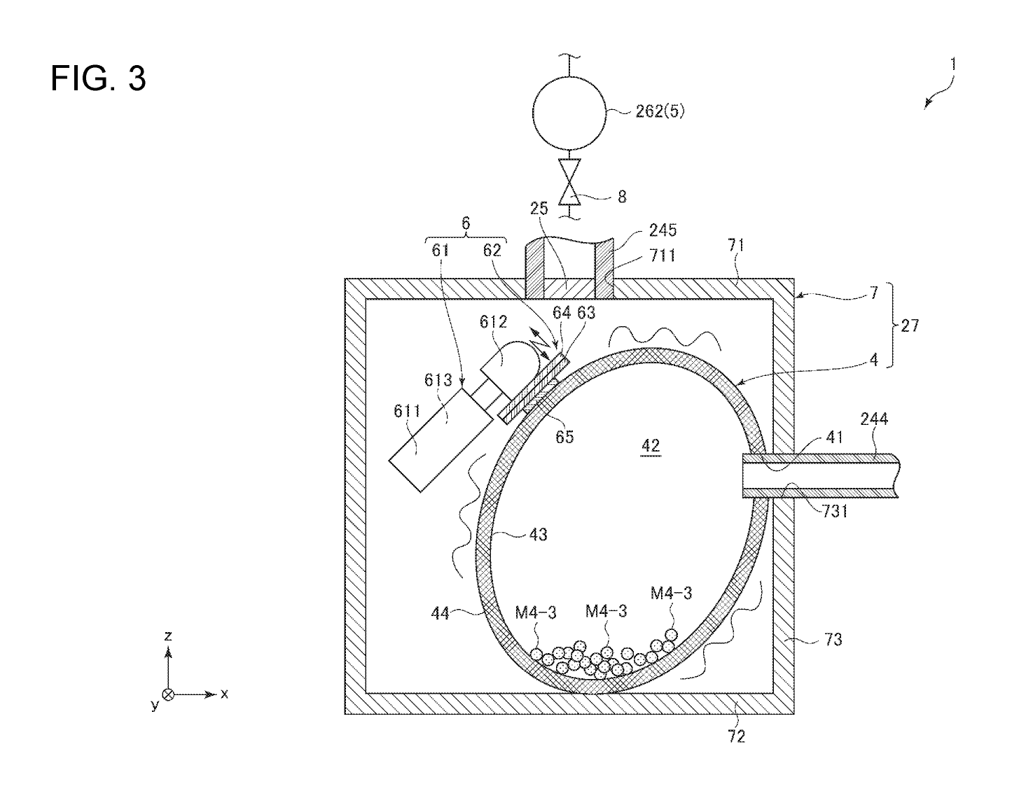

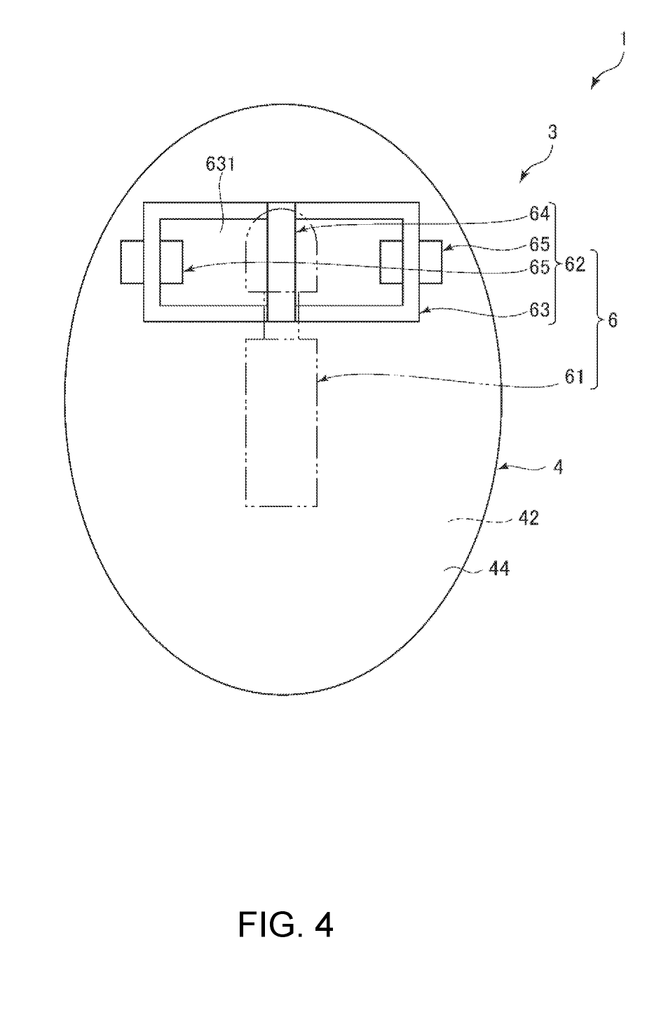

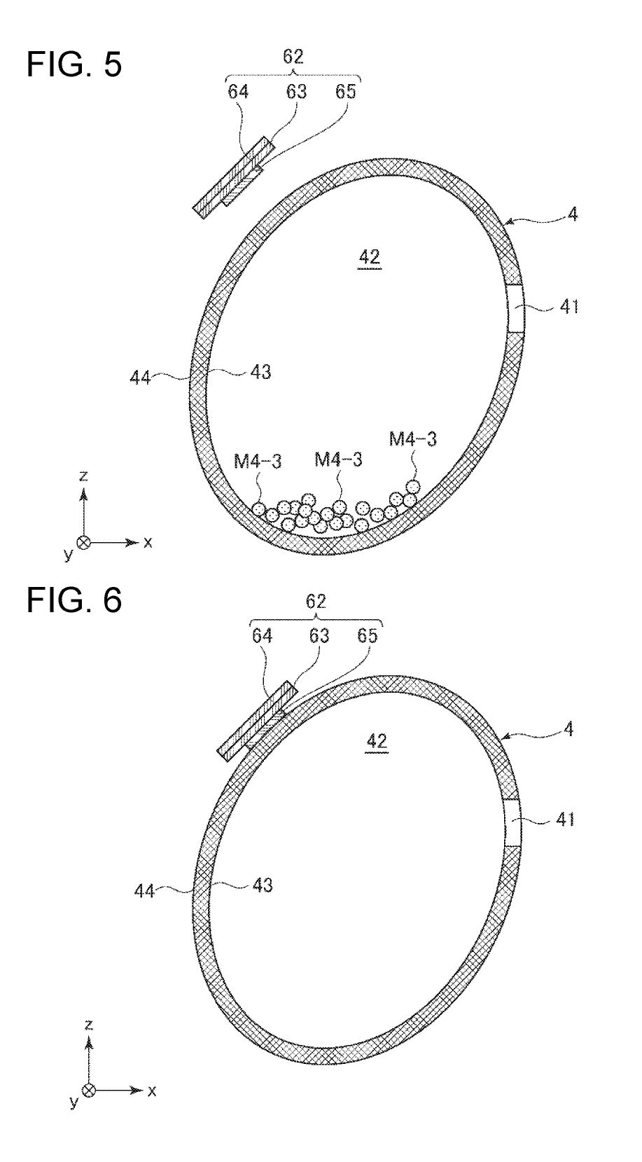

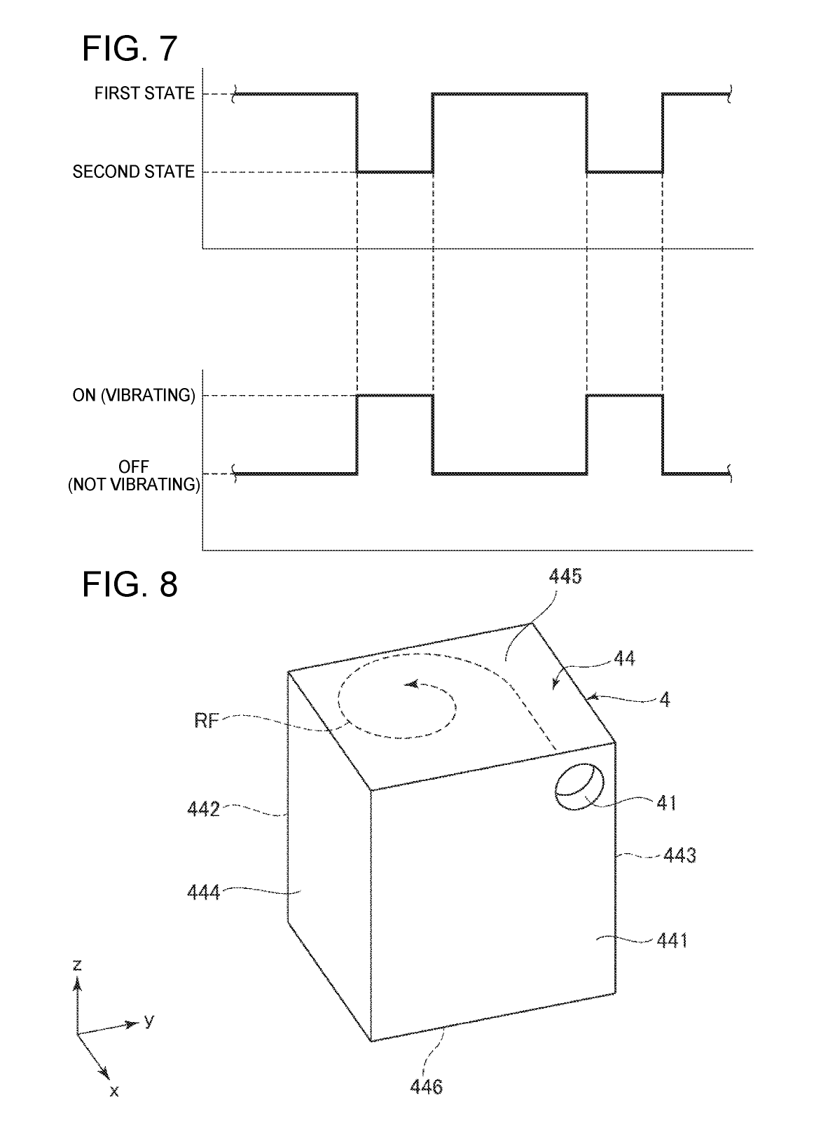

FIG. 1 is a schematic side view of a sheet manufacturing apparatus according to the invention (first embodiment). FIG. 2 and FIG. 3 are schematic side views showing the configuration of a material processing device of the sheet manufacturing apparatus shown in FIG. 1. FIG. 4 is a view from the direction of arrow A in FIG. 2. FIG. 5 and FIG. 6 are schematic side views illustrating the process of replacing a bag of the material processing device in the sheet manufacturing apparatus shown in FIG. 1. FIG. 7 is a timing chart illustrating the relationship between operation of a valve and operation of a vibrator of the material processing device in the sheet manufacturing apparatus shown in FIG. 1.

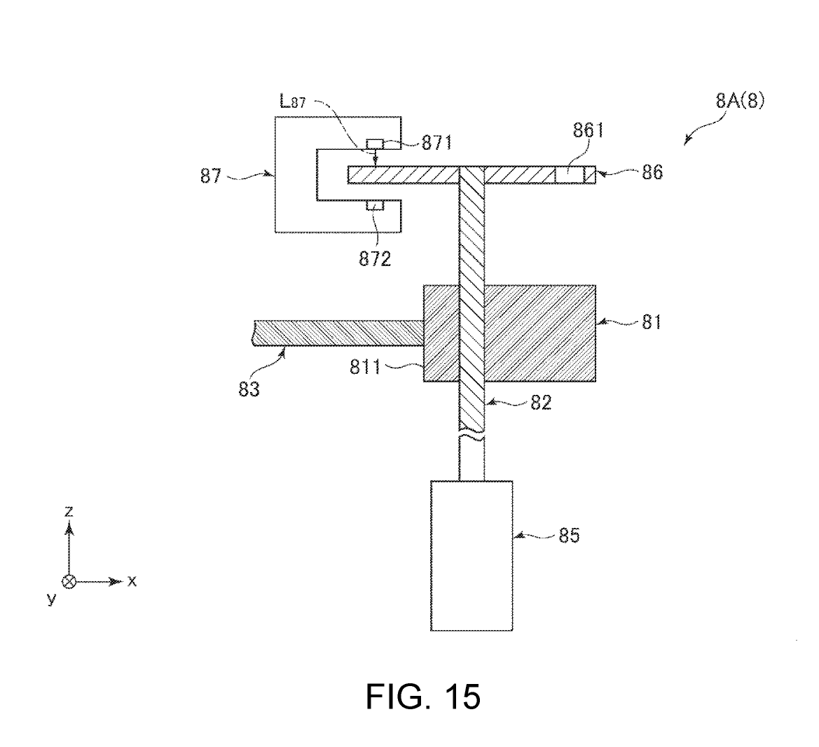

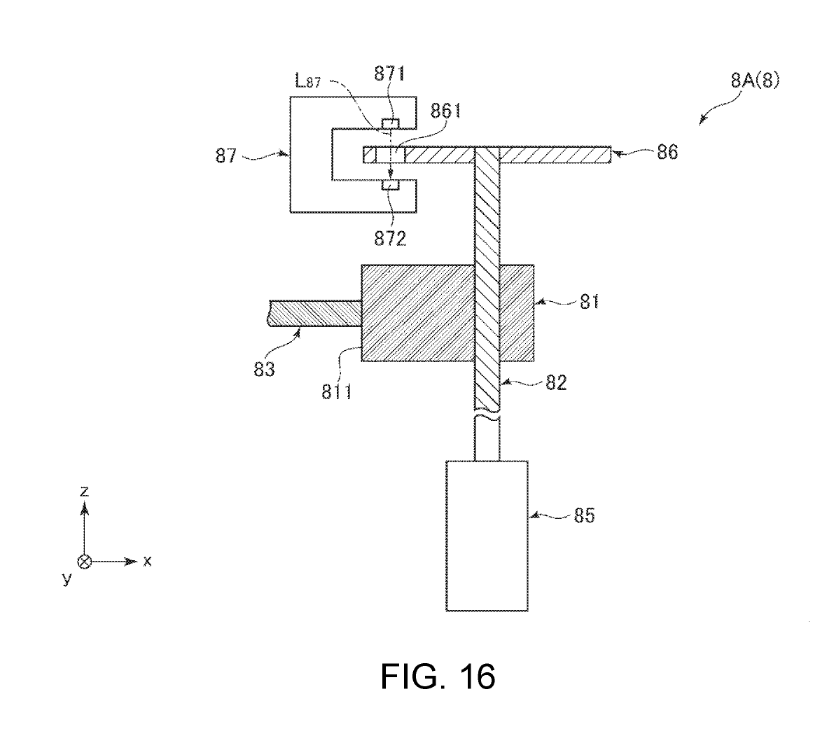

Note that for convenience below, embodiments of the invention are described with reference to three mutually perpendicular axes, an X-axis, Y-axis, and Z-axis, as shown in FIG. 1. The x-y plane containing the X-axis and Y-axis is horizontal, and the Z-axis is vertical, perpendicular to the x-y plane. The directions indicated by the arrow on each axis is referred to as the forward or positive direction, and the opposite direction as the reverse or negative direction. In addition, in FIG. 1 to FIG. 3, and FIG. 4 and FIG. 5, (and in FIG. 8 to FIG. 11, FIG. 15, and FIG. 16), the side at the top is referred to as up or above; and the side at the bottom is referred to as down or below.

As shown in FIG. 1, the defibrating device 1 according to this embodiment has a defibrator 13 for defibrating feedstock M1 containing fiber (material containing fiber) and producing defibrated material M3; a classifier 14 for separating the defibrated material M3 into first screened material M4-1 and second screened material M4-2; a mesh belt 151 (first web forming device 15) that functions as a separator 29 that separates dust M4-3 (unnecessary defibrated material) contained in the first screened material M4-1 (defibrated material M3) from the first screened material M4-1 (defibrated material M3); and a dust collector 3 that captures the dust M4-3 separated by the mesh belt 151 (separator 29).

As shown in FIG. 2, the dust collector 3 comprises at least one (in this embodiment, only one) bag 4, a pressure control device (suction device, vacuum) 5, and a vibration device 6. The bag 4 is a breathable bag 4, has an inlet 41 through which air (gas) GS and dust M4-3 enter, and captures the dust M4-3 entering through the inlet 41. The pressure control device 5 produces positive pressure inside the bag 4 relative to outside of the bag 4. The vibration device 6 applies vibration to the bag 4.

As dust M4-3 is captured by the bag 4 of the dust collector 3, the dust M4-3 gradually accumulates on the inside surface 43 of the bag 4. As dust M4-3 continues to accumulate, the bag 4 becomes clogged, and the degree of positive pressure inside the bag 4 produced by the pressure control device 5 drops. As a result, it may become difficult to sufficiently capture dust M4-3.

As described further below, when the vibration device 6 operates in the invention, the vibration from the vibration device 6 causes the dust M4-3 on the inside surface 43 of the bag 4 to separate and fall (FIG. 2 and FIG. 3). This can prevent clogging of the bag 4, and thereby maintain sufficient positive pressure in the bag 4. As a result, dust M4-3 can be consistently captured for a longer time.

Note that the dust collector 3 is disposed at the downstream end of the conduit 244 in this embodiment (see FIG. 1), but the invention is not so limited and may also be disposed on the downstream side of conduit 246 described below.

The sheet manufacturing apparatus 100 (recovered paper recycling system) of the invention includes a material processing device 1, and is configured to make sheets S from defibrated material M3 from which dust M4-3 was removed.

The invention thus comprised can make sheets S (paper) from defibrated material M3 (can make recycled sheets S) while receiving the benefits of the material processing device 1 described above.

As shown in FIG. 1, the sheet manufacturing apparatus 100 has a feedstock supply device 11, a shredder 12, a defibrator 13, a classifier 14, a first web forming device 15, a cutter 16, a mixing device 17, a detangler 18, a second web forming device 19, a sheet forming device 20, a sheet cutter 210, a stacker 220, and a dust collector 27. The sheet manufacturing apparatus 100 also has wetting unit 231, wetting unit 232, wetting unit 233, wetting unit 234, wetting unit 235, and wetting unit 236. The sheet manufacturing apparatus 100 also has a blower 261, blower 262, and blower 263.

In this embodiment of the invention, the feedstock supply device 11, shredder 12, defibrator 13, classifier 14, first web forming device 15, dust collector 27, wetting unit 231, wetting unit 232, wetting unit 235, blower 261, and blower 262 are configured to make a material processing device 1 that processes feedstock M1 to a form appropriate for making sheets S. Note that the configuration of the material processing device 1 is not so limited, and may be configured without at least one of the feedstock supply device 11, shredder 12, classifier 14, wetting unit 231, wetting unit 232, wetting unit 235, and blower 261.

In the material processing device 1, the dust collector 27 and blower 262 are configured as a dust collector 3 that captures dust M4-3.

Note that parts (such as the pressure control device 5 of the material processing device 1, the vibrator 61 of the vibration device 6, and the valve 8) of the sheet manufacturing apparatus 100 are controlled by a controller 28. This controller 28 may be built into the sheet manufacturing apparatus 100, or disposed to an external device such as an externally connected computer. The external device may connect to and communicate with the sheet manufacturing apparatus 100 through a cable or wirelessly, or connect to the sheet manufacturing apparatus 100 through a network (including the Internet).

The sheet manufacturing apparatus 100 executes, in order, a feedstock supply process, a shredding process, a defibrating process, a classification process, a first web forming process, a cutting process, a mixing process, a detangling process, a second web forming process, a sheet forming process, and a sheet cutting process.

The configurations of selected parts are described below.

The feedstock supply device 11 is the part that executes the feedstock supply process supplying feedstock M1 to the shredder 12. The feedstock M1 is a sheet material containing fiber (cellulose fiber).

The cellulose fiber may be any fibrous material containing mainly cellulose (narrowly defined cellulose) as a chemical compound, and in addition to cellulose (narrowly defined cellulose) may include hemicellulose or lignin. The form of the feedstock M1 is not specifically limited, and it may be woven cloth or non-woven cloth. The feedstock M1 may also be recycled paper manufactured (recycled) by defibrating paper or recovered paper, or synthetic Yupo paper (R), and does not need to be recycled paper. In this embodiment, the feedstock M1 is previously used recovered paper.

The shredder 12 is the part that executes the shredding process of shredding the feedstock M1 supplied from the feedstock supply device 11 in air (ambient air). The shredder 12 has a pair of shredder blades 121 and a chute (hopper) 122.

By turning in mutually opposite directions of rotation, the pair of shredder blades 121 shred the feedstock M1 passing therebetween, that is, cut the feedstock M1 into small shreds M2. The size and shape of the shreds M2 are preferably appropriate to the defibration process of the defibrator 13, and in this example are preferably pieces 100 mm or less on a side, and are further preferably pieces that are greater than or equal to 10 mm and less than or equal to 70 mm per side.

The chute 122 is located below the pair of shredder blades 121, and in this example is funnel-shaped. As a result, the chute 122 can easily catch the shreds M2 that are shredded and dropped by the shredder blades 121.

Above the chute 122, a wetting unit 231 is disposed beside the pair of shredder blades 121. The wetting unit 231 wets the shreds M2 in the chute 122. This wetting unit 231 has a filter (not shown in the figure) containing water, and is configured as a heaterless humidifier (or heated humidifier) that supplies a moist stream of air to the shreds M2 by passing air through the filter. By wet air being supplied to the shreds M2, accumulation of shreds M2 on the chute 122 due to static electricity can be suppressed.

The chute 122 connects to the defibrator 13 through a conduit (flow channel) 241. The shreds M2 collected in the chute 122 passes through the conduit 241 and are conveyed to the defibrator 13.

The defibrator 13 is the part that executes the defibrating process (see FIG. 5) that defibrates the shreds M2 in a dry process in air. Defibrated material M3 can be produced from the shreds M2 by the defibration process of the defibrator 13.

As used herein, defibrate means to break apart and detangle into single individual fibers shreds M2 composed of many fibers bonded together. The resulting detangled fibers are the defibrated material M3. The shape of the defibrated material M3 is strands and ribbons. The defibrated material M3 may also contain clumps, which are multiple fibers tangled together into clumps.

The defibrator 13 in this embodiment of the invention, for example, is configured as an impeller mill having a rotor that turns at high speed, and a liner disposed around the rotor. Shreds M2 introduced to the defibrator 13 are defibrated between the rotor and the liner.

The defibrator 13, by rotation of the rotor, produces an air flow (current) from the shredder 12 to the classifier 14. As a result, shreds M2 can be suctioned from the conduit 241 to the defibrator 13. In addition, after the defibration process, the defibrated material M3 can be fed through another conduit 242 to the classifier 14.

A blower 261 is disposed in the conduit 242. The blower 261 is an air current generator that produces a flow of air to the classifier 14. Conveyance of the defibrated material M3 to the classifier 14 is thereby promoted.

The classifier 14 is the part that executes the classification process of classifying the defibrated material M3 based on the length of the fibers. In the classifier 14, the defibrated material M3 is separated into first screened material M4-1, and second screened material M4-2 that is larger than the first screened material M4-1. The first screened material M4-1 is of a size appropriate to manufacturing sheets S downstream.

The average length of the fibers is preferably greater than or equal to 1 μm and less than or equal to 3000 μm, and less than 50 μm².

The second screened material M4-2 includes, for example, fiber that has not been sufficiently defibrated, and excessively agglomerated (clumped) defibrated fibers.

The classifier 14 includes a drum 141, and a housing 142 enclosing the drum 141.

The drum 141 is a sieve comprising a cylindrical mesh body that rotates on its center axis. The defibrated material M3 is introduced to the drum 141. By the drum 141 rotating, defibrated material M3 that is smaller than the mesh passes through and is separated as first screened material M4-1, and defibrated material M3 that is larger than the mesh and therefore does not pass through, is separated as second screened material M4-2.

The first screened material M4-1 drops from the drum 141.

The second screened material M4-2 is discharged to the conduit (flow path) 243 connected to the drum 141. The end of the conduit 243 on the opposite end (downstream end) as the drum 141 is connected to another conduit 241. The second screened material M4-2 that passes through the conduit 243 merges with the shreds M2 inside the conduit 241, and is introduced with the shreds M2 to the defibrator 13. As a result, the second screened material M4-2 is returned to the defibrator 13 and passes through the defibrating process with the shreds M2.

The first screened material M4-1 from the drum 141 is dispersed while dropping through air, and descends toward the first web forming device 15 located below the drum 141. The first web forming device 15 is the part that executes a first web forming process forming a first web M5 from the first screened material M4-1. The first web forming device 15 includes a mesh belt (separation belt) 151, three tension rollers 152, and a suction unit (suction mechanism) 153.

The mesh belt 151 is an endless belt on which the first screened material M4-1 accumulates. This mesh belt 151 is mounted on three tension rollers 152. By rotationally driving the tension rollers 152, the first screened material M4-1 deposited on the mesh belt 151 is conveyed downstream.

The size of the first screened material M4-1 is greater than or equal to the size of the mesh in the mesh belt 151. As a result, passage of the first screened material M4-1 through the mesh belt 151 is limited, and as a result the first screened material M4-1 accumulates on the mesh belt 151. Furthermore, because the first screened material M4-1 is conveyed downstream by the mesh belt 151 as the first screened material M4-1 accumulates on the mesh belt 151, the first screened material M4-1 is formed in a layer as a first web M5.

The first screened material M4-1 may also contain defibrated material M3 that can pass through without accumulating on the mesh belt 151, as well as other kinds of dust and dirt. The dust M4-3 may be produced by shredding and defibration. Such dust M4-3 is later recovered by the dust collector 27 described below.

The suction unit 153 suctions air from below the mesh belt 151. As a result, dust M4-3 such as dust and dirt that passes through the mesh belt 151 can be suctioned with the air.

The suction unit 153 is connected to a dust collector 27 (recovery device) through another conduit (flow path) 244. Dust M4-3 suctioned by the suction unit 153 is captured by the dust collector 27.

Another conduit (flow path) 245 is also connected to the dust collector 27. A blower 262 is disposed to the conduit 245. Operation of the blower 262 produces suction in the suction unit 153. This promotes formation of the first web M5 on the mesh belt 151. Dust M4-3 is therefore removed from the material forming the first web M5. Operation of the blower 262 causes the dust M4-3 to pass through the conduit 244 to the dust collector 27.

The housing 142 is connected to a wetting unit 232. Like the wetting unit 231 described above, the wetting unit 232 is a heaterless humidifier. As a result, humidified air is supplied into the housing 142. This wet air moistens the first screened material M4-1, and as a result can suppress accretion of the first screened material M4-1 on the inside walls of the housing 142 due to static electricity.

Another wetting unit 235 is disposed downstream from the classifier 14. This wetting unit 235 is configured as an ultrasonic humidifier that mists water. As a result, moisture can be supplied to the first web M5, and the moisture content of the first web M5 can thereby be adjusted. This adjustment can also suppress sticking of the first web M5 to the mesh belt 151 due to static electricity. As a result, the first web M5 easily separates from the mesh belt 151 at the tension roller 152 from where the mesh belt 151 returns to the upstream side.

On the downstream side of the wetting unit 235 is a cutter 16. The cutter 16 is a part that executes a cutting process of cutting the first web M5 that has separated from the mesh belt 151.

The cutter 16 has a propeller 161 that is rotationally supported, and a housing 162 that houses the propeller 161. The first web M5 is cut into pieces as it is fed into the rotating propeller 161. The cut first web M5 forms shreds M6. The shreds M6 then drop down in the housing 162.

The housing 162 is connected to another wetting unit 233. Like the wetting unit 231 described above, the wetting unit 233 is a heaterless humidifier. As a result, wet air is supplied into the housing 162. This wet air suppresses sticking of the shreds M6 to the propeller 161 and to the inside walls of the housing 162 due to static electricity.

A mixing device 17 is disposed on the downstream side of the cutter 16. The mixing device 17 is the part that executes a process of mixing the shreds M6 with resin P1. The mixing device 17 includes a resin supply device 171, a conduit (flow path) 172, and a blower 173.

The conduit 172 connects to the housing 162 of the cutter 16 and the housing 182 of the detangler 18, and is a flow path through which a mixture M7 of the shreds M6 and resin P1 passes.

The resin supply device 171 connects to the conduit 172. The resin supply device 171 has a screw feeder 174. By rotationally driving the screw feeder 174, the resin P1 can be supplied in powder or particle form to the conduit 172. The resin P1 supplied to the conduit 172 is mixed with the shreds M6, forming the mixture M7.

Note that the resin P1 bonds fibers together in a downstream process, and may be a thermoplastic resin or a thermosetting resin, but is preferably a thermoplastic resin. Examples of such thermoplastic resins include AS resin, ABS resin, polyethylene, polypropylene, ethylene-vinylacetate copolymer (EVA), or other polyolefin, denatured polyolefins, polymethylmethacrylate or other acrylic resin, polyvinyl chloride, polystyrene, polyethylene terephthalate, polybutylene terephthalate or other polyesters, nylon 6, nylon 46, nylon 66, nylon 610, nylon 612, nylon 11, nylon 12, nylon 6-12, nylon 6-66 or other polyimide (nylon), polyphenylene ether, polyacetal, polyether, polyphenylene oxide, polyether ether ketone, polycarbonate, polyphenylene sulfide, thermoplastic polyimide, polyether imide, aromatic polyester, or other liquid crystal polymer, styrenes, polyolefins, polyvinyl chlorides, polyurethanes, polyesters, polyimides, polybutadienes, transpolyisoprenes, fluoroelastomers, polyethylene chlorides and other thermoplastic elastomers, as well as combinations of one or two or more of the foregoing. Preferably, a polyester or resin containing a polyester is used as the thermoplastic resin.

Additives other than resin P1 may also be supplied from the resin supply device 171, including, for example, coloring agents for adding color to the fiber, anti-blocking agents for suppressing clumping of the fiber and clumping of the resin P1, flame retardants for making the fiber and manufactured sheets difficult to burn, and paper strengtheners for increasing the strength of the sheets S. Compounds already incorporating such additives with the resin P1 may also be supplied from the resin supply device 171.

The blower 173 is disposed to the conduit 172 downstream from the resin supply device 171. The shreds M6 and resin P1 are also mixed by the action of a rotating device such as the blades of the blower 173. The blower 173 is configured to produce an air flow toward the detangler 18. This air current can also mix the shreds M6 and resin P1 inside the conduit 172. As a result, the mixture M7 can be introduced to the detangler 18 as a uniform dispersion of the shreds M6 and resin P1. The shreds M6 in the mixture M7 are further detangled into smaller fibers while travelling through the conduit 172.

The detangler 18 is the part that executes the detangling process (see FIG. 5) that detangles interlocked fibers in the mixture M7.

The detangler 18 includes a drum 181 and a housing 182 that houses the drum 181.

The drum 181 is a sieve comprising a cylindrical mesh body that rotates on its center axis. The mixture M7 is introduced to the drum 181. By the drum 181 rotating, fiber in the mixture M7 that is smaller than the mesh can pass through the drum 181. The mixture M7 is detangled in this process.

The mixture M7 that is detangled in the drum 181 is dispersed while dropping through air, and falls to the second web forming device 19 located below the drum 181. The second web forming device 19 is the part that executes the second web forming process forming a second web M8 from the mixture M7. The second web forming device 19 includes a mesh belt (separation belt) 191, tension rollers 192, and a suction unit (suction mechanism) 193.

The mesh belt 191 is an endless belt on which the mixture M7 accumulates. This mesh belt 191 is mounted on four tension rollers 192. By rotationally driving the tension rollers 192, the mixture M7 deposited on the mesh belt 191 is conveyed downstream.

Most of the mixture M7 on the mesh belt 191 is larger than the mesh in the mesh belt 191. As a result, the mixture M7 is suppressed from passing through the mesh belt 191, and therefore accumulates on the mesh belt 191. The mixture M7 is conveyed downstream by the mesh belt 191 as the mixture M7 accumulates on the mesh belt 191, and is formed in a layer as the second web M8.

The suction unit 193 suctions air down from below the mesh belt 191. As a result, the mixture M7 can be pulled onto the mesh belt 191, and accumulation of the mixture M7 on the mesh belt 191 is thereby promoted.

Another conduit (flow path) 246 is connected to the suction unit 193. A blower 263 is also disposed to the conduit 246. Operation of the blower 263 produces suction in the suction unit 193.

Another wetting unit 234 is connected to the housing 182. Like the wetting unit 231 described above, the wetting unit 234 is a heaterless humidifier. As a result, wet air is supplied into the housing 182. By humidifying the inside of the housing 182 by adding wet air, sticking of the mixture M7 to the inside walls of the housing 182 due to static electricity can be suppressed.

Another wetting unit 236 is disposed below the detangler 18. This wetting unit 236 is configured as an ultrasonic humidifier similarly to the wetting unit 235 described above. As a result, moisture can be supplied to the second web M8, and the moisture content of the second web M8 can thereby be adjusted. This adjustment can also suppress sticking of the second web M8 to the mesh belt 191 due to static electricity. As a result, the second web M8 easily separates from the mesh belt 191 at the tension roller 192 from where the mesh belt 191 returns to the upstream side.

Note that the amount of moisture (total moisture content) added by wetting unit 231 to wetting unit 236 is, for example, preferably greater than or equal to 0.5 parts by weight and less than or equal to 20 parts by weight per 100 parts by weight of the material before adding moisture.

A sheet forming device 20 is disposed downstream from the second web forming device 19. The sheet forming device 20 is the part that executes the sheet forming process forming sheets S from the second web M8. This sheet forming device 20 includes a calender 201 and a heater 202.

The calender 201 comprises a pair of calender rolls 203, and the second web M8 can be compressed without heating (without melting the resin P1) by passing the second web M8 between the calender rolls 203. This process increases the density of the second web M8. The second web M8 is then conveyed toward the heater 202. Note that one of the pair of calender rolls 203 is a drive roller that is driven by operation of a motor (not shown in the figure), and the other is a driven roller.

The heater 202 has a pair of heat rollers 204, which can heat while compressing the second web M8 passing between the heat rollers 204. The combination of heat and pressure melts the resin P1 in the second web M8, and bonds fibers through the molten resin P1. As a result, a sheet S is formed.

The sheet S is then conveyed to the sheet cutter 210. Note that one of the pair of heat rollers 204 is a drive roller that is driven by operation of a motor (not shown in the figure), and the other is a driven roller.

A sheet cutter 210 is disposed downstream from the sheet forming device 20. The sheet cutter 210 is the part that executes the sheet cutting process (see FIG. 5) that cuts the continuous sheet S into single sheets S. The sheet cutter 210 includes a first cutter 211 and a second cutter 212.

The first cutter 211 cuts the sheet S in the direction crosswise to the conveyance direction of the sheet S.

The second cutter 212 is downstream from the first cutter 211, and cuts the sheets S in the direction parallel to the conveyance direction of the sheet S.

Sheets S of a desired size are produced by the cutting action of the first cutter 211 and the second cutter 212. The sheets S are then conveyed further downstream and stacked in a stacker 22.

As described above, the sheet manufacturing apparatus 100 has a material processing device 1. The main components of this material processing device 1 are a shredder 12 that shreds feedstock M1, the defibrator 13 that defibrates the shreds M2 of the feedstock M1 and produces defibrated material M3, the classifier 14 that separates the defibrated material M3 into first screened material M4-1 and second screened material M4-2, the first web forming device 15 having a mesh belt 151 (separator 29) that separates dust M4-3 from the first screened material M4-1, and a dust collector 3 that captures the dust M4-3 separated by the mesh belt 151. The shredder 12, defibrator 13, classifier 14, and first web forming device 15 are described further below. The dust collector 3 is described next.

As shown in FIG. 2 and FIG. 3, the dust collector 3 has a bag 4 that captures the dust M4-3; a pressure control device 5 (vacuum) that produces positive pressure inside the bag 4 relative to outside of the bag 4; a vibration device 6 that applies vibration to the bag 4; a housing 7 that houses the bag 4 and vibration device 6; and a valve 8 that switches between supplying (the state shown in FIG. 2) and stopping supplying (the state shown in FIG. 3) the flow of dust M4-3 into the bag 4.

The bag 4 is a filter bag (collection bag) with an internal collection space 42 where the dust M4-3 is captured. The maximum capacity of the bag 4 (collection space 42) is not specifically limited, and in this example is preferably greater than or equal to 1.5 liters and less than or equal to 15 liters, and further preferably is greater than or equal to 5 liters and less than or equal to 10 liters.

In the sheet manufacturing apparatus 100 in this example, the bag 4 and housing 7 together configure the dust collector 27.

The conduit 244 communicates with the bag 4 through an air-tight connection, and forms the inlet 41 through which enters dust M4-3 passing through the conduit 244 with air GS. As shown in FIG. 2, the bag 4 can capture the dust M4-3 flowing in from the inlet 41.

The bag 4 is breathable. As a result, the air GS inflowing through the inlet 41 can pass through the bag 4 (see FIG. 2). The air permeability of the bag 4 as measured using the Frazier air permeability test method, for example, is preferably greater than or equal to 30 cm³/s/cm², and is further preferably greater than or equal to 50 cm³/s/cm² and less than or equal to 150 cm³/s/cm².

The bag 4 allows air GS to pass through, but functions as a filter that obstructs the passage of dust M4-3 and captures the dust M4-3.

The bag 4 is made from a flexible material, and while not specifically limited may be made from polypropylene or other plastic, or a plant fiber such as bamboo or hemp.

As described above, the dust collector 3 has a housing 7 enclosing the bag 4. The housing 7 is disposed to a fixed position inside the material processing device 1, and in this example is a box that is more rigid than the bag 4. The bag 4 can be stably protected by the housing 7, and the bag 4 is thereby prevented f rom being unintentionally compressed. If the bag 4 is unintentionally compressed, the compressed bag 4 will deform and dust M4-3 inside the bag 4 returned from the bag 4 to the conduit 244, that is, the dust M4-3 will backflow. In the dust collector 3 according to this embodiment, however, the housing 7 prevents unintentional compression of the bag 4. As a result, backflow of dust M4-3 can be prevented, and the bag 4 can continue to capture dust M4-3.

A fastener for securing the bag 4 in position when the bag 4 is inside is preferably disposed to the housing 7.

The housing 7 has a top panel 71 disposed at the top, a bottom panel 72 disposed at the bottom, and side walls 73 disposed between the top panel 71 and bottom panel 72.

A connection port 731 enabling a sealed connection to the conduit 244 is formed in one side wall 73. This connection port 731 is a through-hole passing through the thickness of the side wall 73. The conduit 244 connected to the connection port 731 protrudes inside the housing 7, and this protruding end connects to the inlet 41 of the bag 4.

Another connection port 711 enabling a sealed connection to the conduit 245 is formed in the top panel 71. This connection port 711 is also a through-hole passing through the thickness of the top panel 71.

A filter 25 is preferably disposed to the conduit 245 where it connects to the connection port 711.

As described above, a blower 262 is disposed to the conduit 245. In this embodiment, the pressure control device 5 is embodied by the blower 262. Operation of the blower 262 produces a pressure difference between the inside of the bag 4 and the outside of the bag 4 (the space between the housing 7 and the bag 4). As a result, the bag 4 can expand to form a sufficient collection space 42, and dust M4-3 can flow into the collection space 42.

Note that the configuration of the blower 262 is not specifically limited, but preferably produces an air flow of 1 m³/min or more, and further preferably produces an air flow greater than or equal to 2 m³/min and less than or equal to 10 m³/min.

The pressure control device 5 in this embodiment is configured to produce positive pressure inside the bag 4 by suctioning air from outside the bag 4, but the invention is not so limited and may be configured to produce positive pressure inside the bag 4 by pressurizing the inside of the bag 4.

In either case, dust M4-3 flowing into the bag 4 is carried by the air GS, collides with the inside surface 43 of the bag 4, and remains on the inside surface 43. As more dust M4-3 continues flowing in, the dust M4-3 continues to collide with and build up on the inside surface 43 or the dust M4-3 already on the inside surface 43 (see FIG. 2). As this continues, the accumulating dust M4-3 can clog the bag 4, which functions as a filter, and maintaining this filter function becomes increasingly difficult. When this happens, effectively capturing the dust M4-3 becomes difficult when the dust M4-3 flows into the bag 4.

The dust collector 3 (material processing device 1) is therefore configured to solve this problem as described below. The configuration and operation of the dust collector 3 (material processing device 1) are described below.

As shown in FIG. 3, the vibration device 6 is configured to apply vibration to the bag 4, and includes a vibrator 61 supported inside the housing 7, and a vibration transfer panel 62 that transfers vibration from the vibrator 61 to the bag 4.

The vibrator 61 of the vibration device 6 contacts and causes the vibration transfer panel 62 to vibrate. As a result, vibration from the vibrator 61 can be transferred through the vibration transfer panel 62 to a wider surface area of the bag 4. These vibrations separate the dust M4-3 from the inside surface 43 of the bag 4, causing the dust M4-3 to fall to the inside bottom of the bag 4. This reduces clogging of the bag 4 (see FIG. 3). As a result, the filtration effect of the bag 4 can be maintained, and the bag 4 can continue to capture dust M4-3 for a longer time. Because the position of the vibrator 61 relative to the bag 4 (the attitude of the vibrator 61) is maintained whether or not the sheet manufacturing apparatus 100 is operating, the vibrator 61 can reliably cause the bag 4 to vibrate. Note that the dust M4-3 separated from the bag 4 accumulates in the bottom of the bag 4.

The vibrator 61 in this embodiment comprises a vibrator body 611 inside of which is a motor 613, and a vibrator head 612 supported by the vibrator body 611 so that the vibrator head 612 can vibrate. Note that the vibrator 61 is not limited to this configuration.

The vibrator head 612 produces a simple harmonic vibration (oscillation) by operation of the motor 613. This vibration is transferred through the vibration transfer panel 62 to the bag 4. The frequency of this vibration is not specifically limited, but is preferably greater than or equal to 20 Hz and less than or equal to 200 Hz, and is further preferably greater than or equal to 60 Hz and less than or equal to 120 Hz. The amplitude is preferably greater than or equal to 1 mm and less than or equal to 10 mm, and further preferably greater than or equal to 1 mm and less than or equal to 3 mm.

As shown in FIG. 3 (and FIG. 2), the vibration device 6 is disposed in contact with the bag 4. The vibration transfer panel 62 that transfers vibration to the bag 4 is made from a hard material that is stiffer than the bag 4. As shown in FIG. 4, the vibration transfer panel 62 includes a frame 63, a beam 64 disposed in the middle of the frame 63, and supports 65 that secure and support opposite sides (the left and right sides in the figure) of the frame 63, and is disposed in a stacked (laminated) configuration with the supports 65 contacting the bag 4 and the frame 63 between the supports 65 and the beam 64.

As described above, the bag 4 is flexible. As a result, depending on the flexibility of the bag 4, vibrations may not be easily transferred to the bag 4 even when the vibrator 61 vibrates in direct contact with the outside surface 44 of the bag 4. However, vibration can be transferred more efficiently by a configuration that transfers vibration from the vibrator 61 to the bag 4 through a vibration transfer panel 62 that is stiffer than the bag 4.

The frame 63 has an opening 631 that passes through from the side facing the bag 4 to the opposite side (the side toward the vibrator 61). The vibration transfer panel 62 is thus a configuration having an opening 631 formed as a through-hole passing through the frame 63. As a result, loss of permeability in the area where the vibration transfer panel 62 is disposed to the bag 4 can be reduced.

The beam 64 is a flat member bonded to the frame 63 and spanning the opening 631. As shown in FIG. 3, the vibrator head 612 of the vibrator 61 contacts this beam 64. When the vibrator 61 vibrates with the vibrator 61 touching the beam 64, vibration from the vibrator 61 is transferred from the beam 64 to the frame 63, the supports 65, and then to the bag 4.

The supports 65 are disposed to opposite sides of the frame 63 with the opening 631 therebetween. The supports 65 are support members that secure and support the frame 63 on the outside surface 44 of the bag 4.

The vibration transfer panel 62 thus comprised is preferably configured in one of the modes described below.

In a first configuration mode, the frame 63, beam 64, and supports 65 are elastic.

In a second configuration mode, the frame 63 and beam 64 are elastic, and the supports 65 are rigid.

In a third configuration mode, the frame 63 and beam 64 are rigid, and the supports 65 are elastic.

In each of these configurations, at least part of the vibration transfer panel 62 is elastic (flexible). As a result, even if the vibration transfer panel 62 is pushed to the bag 4 side by vibration from the vibrator 61, the vibration transfer panel 62 can rebound, and vibration can be applied continuously to the bag 4 while the vibrator 61 is operating.

As shown in FIG. 3, if the side of the bag 4 into which the inlet 41 opens, that is, the positive side on the X-axis (the right side in FIG. 3) is the front side, the vibration transfer panel 62 is preferably disposed to the opposite side as the front, that is, the back side of the bag 4 (the negative side on the X-axis).

When dust M4-3 flows into the bag 4 and clings to the inside surface 43, the dust M4-3 tends to accumulate on the part of the inside surface 43 located in front of the direction of dust M4-3 travel, that is, the part at the back of the bag 4. Therefore, by disposing the vibration transfer panel 62 at the back of the bag 4, that is, the same side as where the dust M4-3 tends to accumulate on the inside surface 43 of the bag 4, dust M4-3 clinging to the bag 4 can be quickly and sufficiently caused to drop away from the bag 4 by the vibrations transferred to the bag 4 through the vibration transfer panel 62.

The vibration transfer panel 62 is further preferably disposed to a position higher than the inlet 41 in the direction of gravity.

As described above, a conduit 245 connects to the connection port 711 of the top panel 71 of the housing 7. When the blower 262 disposed to the conduit 245 operates, the dust M4-3 in the bag 4 tends to accumulate first on the parts of the inside surface 43 that are higher than the inlet 41. As a result, because the vibration transfer panel 62 is also disposed to a position higher than the inlet 41, dust M4-3 accumulated to this higher part of the inside surface 43 can be quickly and sufficiently separated from the inside surface 43 by the vibration transferred thereto through the vibration transfer panel 62. As a result, dust M4-3 accumulated on the higher parts of the inside surface 43 can be made to fall to the bottom (floor) of the bag 4 by the vibration transferred through the vibration transfer panel 62.

Note that the location of the vibration transfer panel 62 is not limited to the location described in this embodiment.

When the bag 4 has captured a sufficient amount of dust M4-3, the bag 4 is replaced by a new, that is, an unused and empty, bag 4. In this case, as shown in FIG. 5 and FIG. 6, the vibration transfer panel 62 can preferably be freely removed and attached to the new bag 4. As a result, the vibration transfer panel 62 can be installed to the unused bag 4 and reused, which is preferable economically and environmentally.

A cover (not shown in the figure) may be applied to the inlet 41 of the used bag 4 containing dust M4-3, and the bag 4 then thrown away. This reduces the likelihood of the worker replacing the bag 4 inhaling the dust M4-3 inside the bag 4, and enables sanitary disposal of the bag 4 and contents.

Note that the bag 4 preferably has a marker (not shown in the figure) indicating where to attach the vibration transfer panel 62. This enables attaching the vibration transfer panel 62 to the correct location on the bag 4.

The vibration transfer panel 62 is not limited to being removably attached to the bag 4, and depending on the materials used for the vibration transfer panel 62, may be replaced and disposed of with the bag 4. This eliminates the need to remove and attach the vibration transfer panel 62 when replacing the bag 4, and thereby enables more quickly replacing the bag 4.

The dust collector 3 also has a valve 8 that can change between a first state (see FIG. 2) allowing dust M4-3 to flow into the inlet 41, and a second state (see FIG. 3) stopping the inflow of dust M4-3 to the inlet 41. The valve 8 is disposed to the conduit 245 on the upstream side of the blower 262. The configuration is not specifically limited, and in one example is a solenoid valve.

As shown in FIG. 7, operation switches repeatedly between the first state and second state. The vibration device 6 applies vibration to the bag 4, that is, causes the bag 4 to vibrate, in the second state. In the first state, the vibration device 6 stops applying vibration to the bag 4, that is, stops vibration of the bag 4.

For example, if the bag 4 vibrates in the first state, the dust M4-3 that separates from the inside surface 43 may simply stick to the inside surface 43 again. As a result, by stopping the inflow of dust M4-3 when vibration is applied, re-accumulation of the dust M4-3 on the inside surface 43 can be reduced.

### Embodiment 2

FIG. 8 is an oblique view of the bag in a material processing device according to a second embodiment of the invention.

The second embodiment of a material processing device and sheet manufacturing apparatus according to the invention are described below with reference to the accompanying figures, focusing on the differences between this and the foregoing embodiment, and omitting or simplifying further description of like elements.

This embodiment differs from the first embodiment described above in the outside shape of the inflated bag and the location of the inlet.

As shown in FIG. 8, when inflated, the bag 4 in this embodiment of the invention is a cube or other hexahedron. As a result, the outside surfaces 44 of the bag 4 may be identified as a first surface 441 facing the positive X-axis side; a second surface 442 facing the negative X-axis side; a third surface 443 facing the positive Y-axis side; a fourth surface 444 facing the negative Y-axis side; a fifth surface 445 facing the positive Z-axis side; and a sixth surface 446 facing the negative Z-axis side. The inlet 41 is formed in the first surface 441.

When the side in which the inlet 41 of the bag 4 opens, that is, the first surface 441, is referred to as the front, the inlet 41 is located offset (shifted) to the positive Y-axis side from the center of the front (first surface 441). As a result, when the dust M4-3 flows with the air GS in from the inlet 41, a spiral flow RF around the Z-axis is formed inside the bag 4. When seen from the fifth surface 445 side, this spiral flow RF turns counterclockwise. This spiral flow RF produces an even more effective filtration effect by causing the dust M4-3 to circulate along the inside surfaces 43 of the bag 4. The dust M4-3 clinging to the inside surface 43 of the bag 4 can also be easily removed.

### Embodiment 3

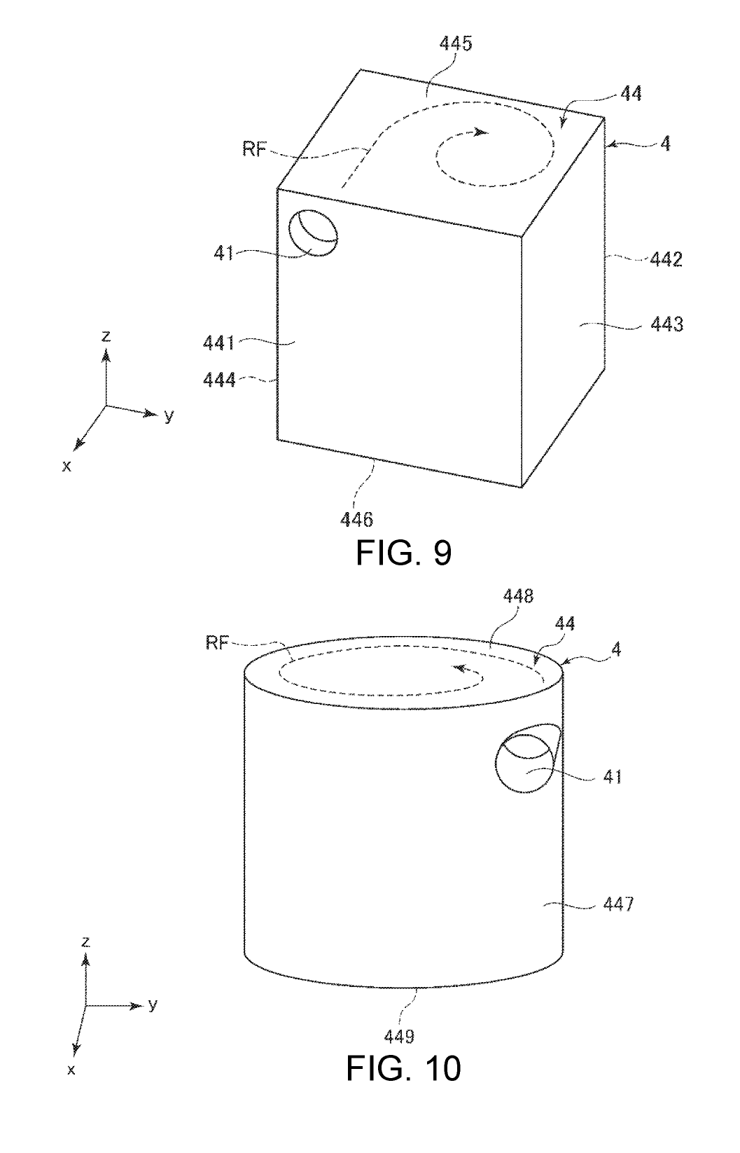

FIG. 9 is an oblique view of the bag in a material processing device according to a third embodiment of the invention.

The third embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the second embodiment described above except for the location of the inlet to the bag.

As shown in FIG. 9, when the side in which the inlet 41 of the bag 4 opens, that is, the first surface 441, is referred to as the front, the inlet 41 is located offset (shifted) to the negative Y-axis side from the center of the front (first surface 441). As a result, when the dust M4-3 flows with the air GS in from the inlet 41, a spiral flow RF around the Z-axis is formed inside the bag 4. When seen from the fifth surface 445 side, this spiral flow RF turns counterclockwise. This spiral flow RF produces an even more effective filtration effect by causing the dust M4-3 to circulate along the inside surfaces 43 of the bag 4. The dust M4-3 clinging to the inside surface 43 of the bag 4 can also be easily removed.

The direction of the spiral flow RF in this embodiment is the opposite of the direction of spiral flow RF circulation in the second embodiment, but otherwise the effect of this embodiment is the same as the second embodiment.

### Embodiment 4

FIG. 10 is an oblique view of the bag in a material processing device according to the fourth embodiment of the invention.

The fourth embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the second embodiment except for the outside shape of the bag.

As shown in FIG. 10, when inflated, the bag 4 in this embodiment of the invention is cylindrical. As a result, the outside surfaces 44 of the bag 4 may be identified as a first surface 447 of the circumference around the Z-axis; a second surface 448 facing the positive Z-axis side; and a third surface 449 facing the negative Z-axis side. The inlet 41 is formed in the first surface 447. In this embodiment, the inlet 41 protrudes in a tubular configuration to the positive X-axis side.

When the side in which the inlet 41 of the bag 4 opens, that is, the side on the positive X-axis side is referred to as the front, the inlet 41 is located offset (shifted) to the positive Y-axis side from the center of the front. As a result, when the dust M4-3 flows with the air GS in from the inlet 41, a spiral flow RF around the Z-axis is formed inside the bag 4. When seen from the second surface 448 side, this spiral flow RF turns counterclockwise. This spiral flow RF produces an even more effective filtration effect by causing the dust M4-3 to circulate along the inside of the first surface 447 of the bag 4. The dust M4-3 clinging to the inside surface 43 of the bag 4 can also be easily removed.

### Embodiment 5

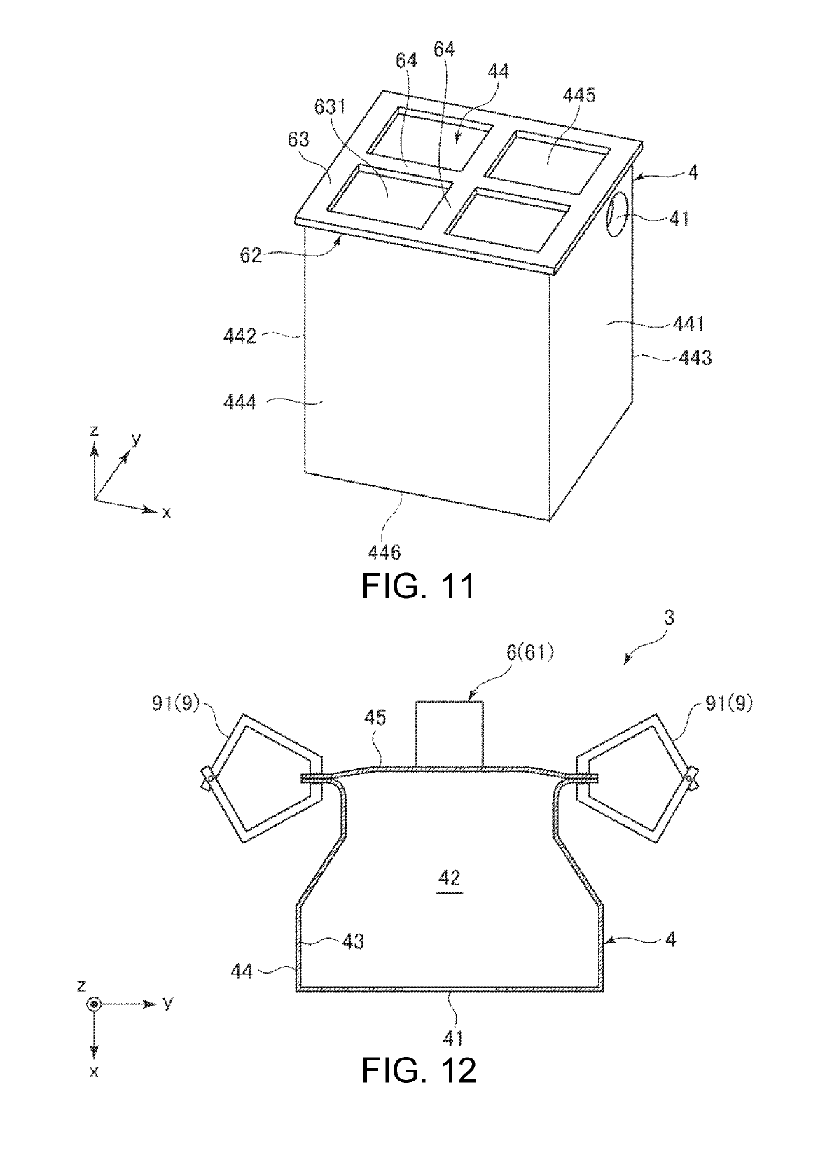

FIG. 11 is an oblique view of the bag in a material processing device according to the fifth embodiment of the invention.

The fifth embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the second embodiment except for the configuration of the vibration transfer panel.

As shown in FIG. 11, the vibration transfer panel 62 is formed with two beams 64 on the inside of the opening 631 of the frame 63. One beam 64 of the two beams 64 extends on the X-axis, and the other beam 64 extends on the Y-axis, and the two beams 64 intersect. Note that the directions in which the beams 64 extend is not limited to this configuration.

This configuration of the vibration transfer panel 62 improves efficiency transferring vibration to the bag 4.

### Embodiment 6

FIG. 12 is a plan view of the bag in a material processing device according to a sixth embodiment of the invention.

The sixth embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the first embodiment described above except for the configuration of the dust collector.

As shown in FIG. 12, the dust collector 3 has a tensioner 9 that applies tension to the back side of the bag 4, that is, the part on the negative X-axis side (referred to as back 45 below).

The tensioner 9 has a pair of clips 91 to hold the back 45. When the clips 91 are holding the back 45 and the clips 91 are moved away from each other, tension is applied to the back 45. This vibrator 61 contacts the back 45. As a result, vibration can be applied to the bag 4 without using the vibration transfer panel 62.

Note that this embodiment omits the vibration transfer panel 62, but the invention is not so limited and a vibration transfer panel 62 may be disposed to the back 45.

### Embodiment 7

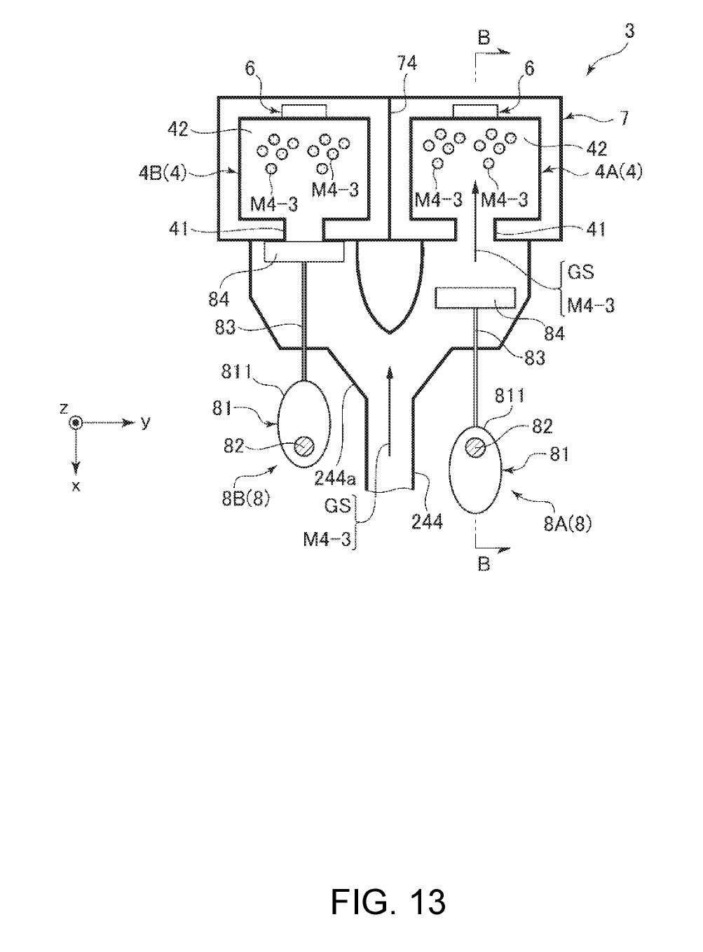

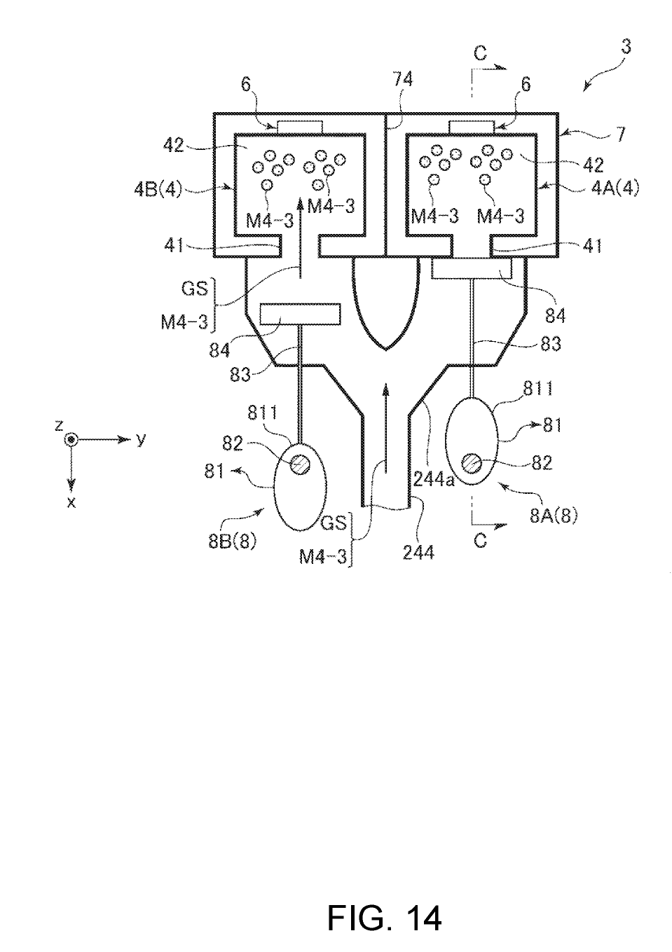

FIG. 13 and FIG. 14 are plan views illustrating the configuration of a material processing device according to a seventh embodiment of the invention. FIG. 15 is a section view through line B-B in FIG. 13, and FIG. 16 is a section view through line C-C in FIG. 14.

The seventh embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the first embodiment except for the configuration of the dust collector.

As shown in FIG. 13 and FIG. 14, the dust collector 3 in this embodiment has two bags 4. Of the two bags 4, one is referred to as the first bag 4A, and the other as the second bag 4B.

The inside of the housing 7 is segmented by a divider 74 into two chambers, and the first bag 4A and second bag 4B are disposed in the separate chambers with respective vibration devices 6.

The conduit 244 also branches in two at junction 244a, and connects to the first bag 4A and second bag 4B.

The valve 8 switches the dust collector 3 between a first mode as shown in FIG. 13, and a second mode as shown in FIG. 14.

In the first mode shown in FIG. 13, the first bag 4A (one bag 4 of the two bags 4) is in the first state with vibration not applied thereto, and the dust collector 3 operates to set the second bag 4B (the other bag 4) to the second state applying vibration to the second bag 4B.

In the second mode shown in FIG. 14, the first bag 4A (the one bag 4) is in the second state with vibration applied thereto, and the dust collector 3 operates to set the second bag 4B (the other bag 4) to the first state so that vibration is not applied thereto.

When in the first mode as shown in FIG. 13, this configuration can separate accreted dust M4-3 from the second bag 4B while the first bag 4A continues capturing dust M4-3. When in the second mode as shown in FIG. 14, this configuration can separate accreted dust M4-3 in the first bag 4A while the second bag 4B captures dust M4-3. As a result, accumulated dust M4-3 can be removed while continuing to capture dust M4-3.

As shown in FIG. 13 and FIG. 14, the valve 8 is located upstream of the first bag 4A and second bag 4B. In this embodiment, the valve 8 includes a first valve 8A on the first bag 4A side, and a second valve 8B on the second bag 4B side. Because the first valve 8A and second valve 8B are configured the same, the configuration of the first valve 8A is described below.

The first valve 8A has a cam 81, a cam shaft 82 supporting the cam 81 rotationally on the Z-axis, a follower 83 that slides against the cam surface 811 of the cam 81, and a shutter 84.

As shown in FIG. 15 and FIG. 16, the first valve 8A also has a motor 85 connected to one end of the cam shaft 82, an interrupter 86 connected to the other send of the cam shaft 82, and a transmissive sensor 87 that is interrupted by the interrupter 86.

The cam 81 in this example is a flat, oval member. The outside surface of the cam 81 forms the cam surface 811.

The cam shaft 82 connects to one of the two foci of the cam 81.

The follower 83 is a rod, one end of which contacts the cam surface 811. When the cam 81 turns, the follower 83 slides along the cam surface 811. As a result, the follower 83 moves bidirectionally on the X-axis.

The shutter 84 connects to the other end of the follower 83. As the follower 83 moves bidirectionally on the X-axis, the shutter 84 can move to and away from the inlet 41 to the first bag 4A. As shown in FIG. 13, when the shutter 84 is separated from the inlet 41 to the first bag 4A, the inlet 41 is open and dust M4-3 can flow through the inlet 41 in the first state with vibration not applied to the first bag 4A.

As shown in FIG. 14, when the shutter 84 is closed against the inlet 41 to the first bag 4A, the inlet 41 is closed and dust M4-3 cannot flow through the inlet 41 in the second state with vibration applied to the first bag 4A.

As shown in FIG. 15 and FIG. 16, the motor 85 is connected to the cam shaft 82 and can drive the cam shaft 82 rotationally. Note that by changing the voltage applied to the motor 85, the speed of the cam shaft 82 (cam 81) can be adjusted.

The interrupter 86 is connected to the opposite end of the cam shaft 82 as the motor 85. The interrupter 86 is round with the center thereof connected to the cam shaft 82. A through-hole 861 is formed in part of the interrupter 86.

The transmissive sensor 87 has an emitter 871 that emits light L₈₇, and a photodetector 872 that detects the light L₈₇. When the light L₈₇ is blocked by the interrupter 86 as shown in FIG. 15, the controller 28 detects the first state. When the light L₈₇ passes through the through-hole 861 in the interrupter 86 and is detected by the photodetector 872 as shown in FIG. 16, the controller 28 detects the second state. Note that the emitter 871 may be configured with a light-emitting diode, for example. The photodetector 872 may be configured with a photodiode, for example.

Note that the number of bags 4 in this embodiment is two, but the invention is not so limited and there may be three or more.

The first valve 8A and second valve 8B operate by cam mechanisms in this embodiment, but the invention is not so limited and they may be configured with linkage mechanisms.

The valve 8 is also not limited to the configuration shown in the figures, and may be a solenoid valve disposed at the junction 244a in the conduit 244.

### Embodiment 8

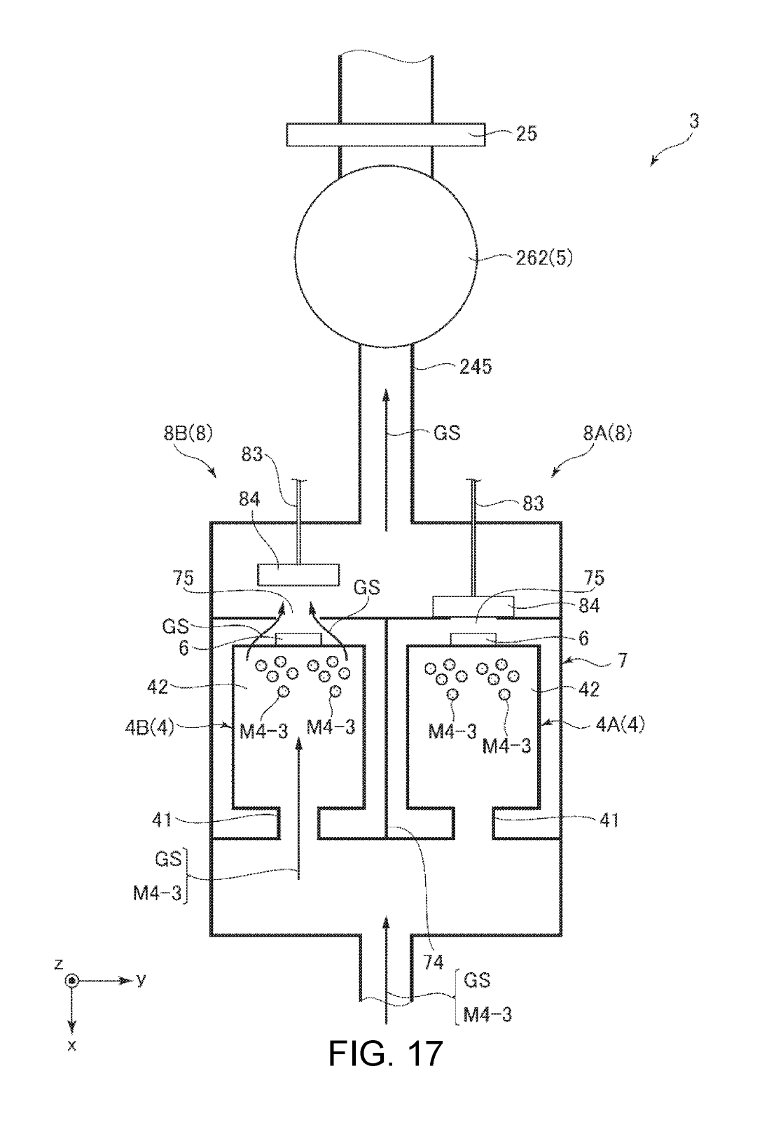

FIG. 17 is a plan view illustrating the configuration of a material processing device according to an eighth embodiment of the invention.

The eighth embodiment of a material processing device and sheet manufacturing apparatus according to the invention are described below with reference to the accompanying figures, focusing on the differences between this and the foregoing embodiments, and omitting or simplifying further description of like elements.

This embodiment is the same as the first embodiment except for the location of the valve.

As shown in FIG. 17, the valve 8 (first valve 8A, second valve 8B) in this embodiment is disposed downstream from the first bag 4A and second bag 4B.

The housing 7 has outlet ports 75 through which air GS flows to the conduit 245. An outlet port 75 is disposed to both first bag 4A and second bag 4B.

The shutter 84 of the first valve 8A can move to and away from the outlet port 75 on the first bag 4A side. When this shutter 84 is separated from the outlet port 75 of the first bag 4A is the first state, and dust M4-3 can flow into the first bag 4A. When this shutter 84 is at the outlet port 75 of the first bag 4A is the second state, the outlet port 75 is closed, and dust M4-3 cannot flow into the first bag 4A (see FIG. 17).

Likewise, the shutter 84 of the second valve 8B can move to and away from the outlet port 75 on the second bag 4B side. When this shutter 84 is separated from the outlet port 75 of the second bag 4B, M4-3 can flow into the second bag 4B, and the second bag 4B is not vibrated in the first state (FIG. 17). When this shutter 84 is at the outlet port 75 of the second bag 4B, the outlet port 75 is closed, the flow of dust M4-3 into the second bag 4B is stopped, and vibration is applied to the second bag 4B in the second state.

Preferred embodiments of the material processing device and sheet manufacturing apparatus according to the invention are described above, but the invention is not so limited and parts of the material processing device and sheet manufacturing apparatus may also replaced with equivalent configurations having the same function. Other configurations may also be added as desired.

In addition, a material processing device and sheet manufacturing apparatus according to the invention may be a combination of any two or more desirable configurations (features) of the embodiments described above.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No: 2018-38517, filed Mar. 5, 2018 is expressly incorporated by reference herein.

What is claimed is:

1. A material processing device comprising:
a defibrator configured to defibrate fibrous feedstock containing fiber and produce defibrated material;
a separator configured to separate dust contained in the defibrated material from the defibrated material; and
a collector configured to capture the dust separated by the separator, and having at least one air permeable bag with an inlet through which the dust inflows with air, and which captures the dust entering through the inlet,
a pressure adjuster configured to positively pressurize the inside of the bag relative to the outside of the bag, and
a vibrator configured to apply vibration to the bag.

2. The material processing device described in claim 1, wherein:
the vibrator has a vibration transfer panel made from a material stiffer than the bag, is disposed in contact with the bag, and transfers vibration to the bag.

3. The material processing device described in claim 2, wherein:
when the side of the bag in which the inlet opens is the front, the vibration transfer panel is disposed to the back side, which is the side opposite the back.

4. The material processing device described in claim 3, wherein:
the vibration transfer panel is disposed to a position higher in the direction of gravity than the inlet.

5. The material processing device described in claim 2, wherein:
the vibration transfer panel has a through-hole formed through the vibration transfer panel.

6. The material processing device described in claim 2, wherein:
the vibration transfer panel is removably attached to the bag.

7. The material processing device described in claim 2, wherein:
the vibrator has a vibrator body that contacts and vibrates the vibration transfer panel.

8. The material processing device described in claim 1, wherein:
when the side of the bag in which the inlet opens is the front, the inlet is disposed to a position offset from the center of the front.

9. The material processing device described in claim 1, wherein:
the collector has a valve configured to change between a first state allowing inflow of the dust through the inlet, and a second state stopping inflow of the dust through the inlet; and
in the second state, the vibrator applies vibration to the bag.

10. The material processing device described in claim 9, wherein:
the collector has two bags; and
the valve, when one of the two bags is in the first state, sets the other bag to the second state; and
when the one bag is in the second state, sets the other bag to the first state.

11. The material processing device described in claim 1, wherein:
the collector has a case housing that houses the bag.

12. A sheet manufacturing apparatus comprising:
the material processing device described in claim 1; and
makes a sheet from the defibrated material from which the dust was separated.
